(19) United States
(12) Patent Application Publication
(10) Pub. No.: US 2008/0094952 A1
(43) Pub. Date: Apr. 24, 2008

(54) Layer jump on a multi-layer disc

(75) Inventors: Robert Albertus Brondijk, Eindhoven (NL); Jurgen Maria Vangeel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,264

(22) PCT Filed: Jul. 12, 2005
(86) PCT No.: PCT/IB05/52303

§ 371 Date: Jan. 18, 2007

(30) Foreign Application Priority Data
Jul. 19, 2004 (EP) 04103439.8
Oct. 20, 2004 (EP) 04105182.2

(51) Int. Cl. G11B 7/00

(52) U.S. Cl. 369/44.29

(57) ABSTRACT

A method and an apparatus for writing on a multi-layer disc are described. The occurrence of a layer jump, due to the fact that e.g. the storage space available on a first layer is exhausted, is anticipated by monitoring the storage space available remaining. When approaching the layer jump a calibration procedure for recording on a second layer is launched, so that when the layer jump is actually taking place, recording can be resumed on the second layer with minimum delay.

The invention relates to a method and to an apparatus for recording information on a recording medium having at least a first information layer and a second information layer.

Recently a dual-layer DVD recordable disc has been introduced, and consequently, apparatuses having the capability to record information on such discs have been developed.

The recording of information on a single-layer disc takes place in the following way the apparatus, or drive, receives from a host, usually a personal computer, one or a series of writing commands, in what is known as a write session. A writing command specifies a portion of information to be recorded on the disc: thereafter the drive executes the command by recording the portion of information on the only layer. The recording of information is dependent on various control parameters, e.g. a laser power, which actual values need to be determined experimentally, usually when the disc is inserted in the apparatus or at the beginning of the write session.

When recording on a dual-layer disc, or more in general a multi-layer disc, it can be foreseen that at some point there is a change of recording layer, known in the art as “layer jump”. A layer jump can occur for example as a result of the exhaustion of free storage space in a layer where information is initially recorded, herein labeled as the first layer.

In a straightforward implementation of a method of recording on a dual layer disc, the write commands are executed as they are received by recording on the first layer as long as it is possible, and, if at any time during recording the storage space of the first layer is exhausted, by continuing to write on the second layer, in other words doing a layer jump. Some control parameters however need different values according to the recording layer, and therefore appropriate values for recording on the second information layer are needed as soon as the recording on the second information layer is started. These appropriate values need to be determined by means of a calibration procedure which has to be accomplished before recording can be resumed on the second layer.

This straightforward method of recording on a dual layer disc has the disadvantage that in some cases it fails in the handling of a write command when a layer jump is involved, the failure possibly implying a reset being given by the host.

It is an object of the invention to provide a method of recording on a multi-layer disc according to which the possibility of a failure in the handling of a writing command is reduced.

It is a further object of the invention to provide an apparatus for recording on a multi-layer disc according to which the possibility of a failure in the handling of a writing command is reduced.

According to the invention the object is achieved by a method as claimed in claim 1.

The invention is based on the recognition that the possible failure in the handling of a write command is due to an excessive duration of the execution of the write command, which results from the need to execute a calibration procedure for at least some of the control parameters, nested in the execution of a write command, at the moment when a layer jump takes place.

According to the invention such a calibration is performed shortly before the layer jump would occur, with the effect of removing, or at least reducing, the possibility that the calibration has to be performed in the middle of a command execution. In other words, when the occurrence of a layer jump is anticipated, the calibration is executed in advance, outside the execution of a write command, so as to prevent a failure during a write command due to the fact that a lengthy calibration nested within it is required. Checking if the condition, or proximity thereto, for a layer jump to occur is met means checking if a layer jump is going to be involved during the execution of a subsequent write command, or of a few subsequent write commands, that is if a layer jump is upcoming.

It is observed that WO 03/105139 A1 describes a method of recording on a multi-layer disc wherein a layer jump is potentially involved and wherein the recording is dependent on an optical power value needs to be adjusted appropriately according to the recording layer. Power settings for said power value are recorded in the disc itself. According to this method, the power settings recorded in the disc are read and stored in a memory during an initialization phase so that when the layer jump takes place the power setting to be used for recording on another layer can quickly be loaded from the memory instead of read from the disc, which would require a relatively longer time, and therefore preventing a momentary pause.

In an embodiment, the method according to the invention further comprises the receiving of a write command, and the checking step follows said receiving, as claimed in claim 4. In other words, receiving a write command triggers the checking step.

In particular the checking step may be carried out as claimed in claim 7. In this case the layer jump is anticipated, or similarly the condition of being in proximity of exhausting the storage space of the first layer is tested, by checking if the portion of information specified by the write command exceeds the free portion of the first layer. If yes, it is clear that the write command is going to involve a layer jump and therefore the calibration is executed in preparation thereof.

In a further embodiment the layer jump is anticipated by checking if the free portion of the first layer is less than a threshold value, as claimed in claim 8. This threshold value can be chosen in such a way that this condition anticipates the occurrence of the layer jump in the next or few next write commands, in which case therefore the calibration is executed.

This check can be done immediately after receiving a write command, but since it is not dependent on the size of the position of information specified by a particular write command, it can also be done at any time while the drive is ready to receive a command. As an alternative, it can also be done regularly after the execution of each command, and possibly, in addition, once at the beginning of the write session, i.e. before starting to receive the series of commands.

According to some operating systems, the portion of information specified by a write command has a maximum size. Therefore, advantageously, the layer jump is anticipated by checking if the free portion of the first layer is less than said maximum size, as claimed in claim 9. If yes, it is possible that the next write command is going to involve a layer jump, in which case therefore the calibration is executed.

The threshold value can also be chosen e.g. 2-3 times the maximum size of the portion of information which can be specified by a write command. It has to be remarked that a too high threshold value is not advisable because this increases the possibility that the write session ends before the layer jump actually takes place, making useless the calibration executed. What is important is to avoid that the calibration procedure is executed without the clear prospect of using its result during the current writing session. In fact the calibration procedure uses a test area which is available in limited quantity, moreover it requires a relatively long time, e.g. up to ten seconds. Furthermore the parameter or parameters to be calibrated may be temperature dependent, and therefore a calibration performed too long in advance may yield results which are not anymore sufficiently accurate at the time when they actually have to be used.

It has been said that the layer jump may occur when the available space on the first layer is exhausted. However in some applications the layer jump may occur even when the available space on the first layer is not exhausted. For example, the layers may be divided in sectors, or tracks. The exhaustion of the available space of a sector may cause a layer jump even if other sectors in the same layer have some available space.

In general, whatever is the condition for a layer jump to occur, according to the invention this condition, or proximity to this condition, is checked so as to anticipate the layer jump and if so to do the necessary preparation, so that when the layer jump actually takes place, the recording can resume on the second layer with minimum delay.

According to the invention the further object is achieved by an apparatus as claimed in claim 11.

As it will appear clear from the foregoing discussion, all advantageous embodiments of the method can be translated into corresponding optional features for the apparatus according to the invention.

These and other aspects of the method and apparatus, or drive, according to the invention will be further elucidated and described with reference to the drawings. In the drawings:

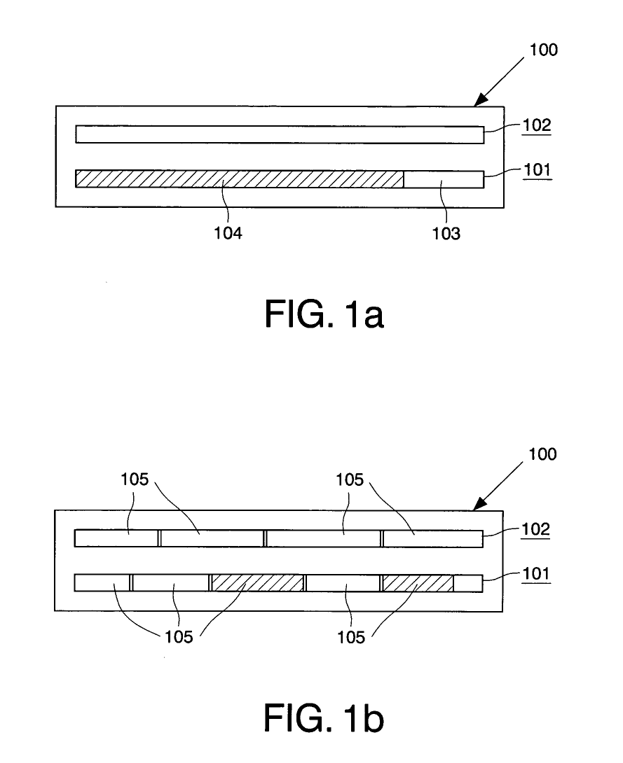

FIGS. 1a and 1b show an optical disc having two information layers,

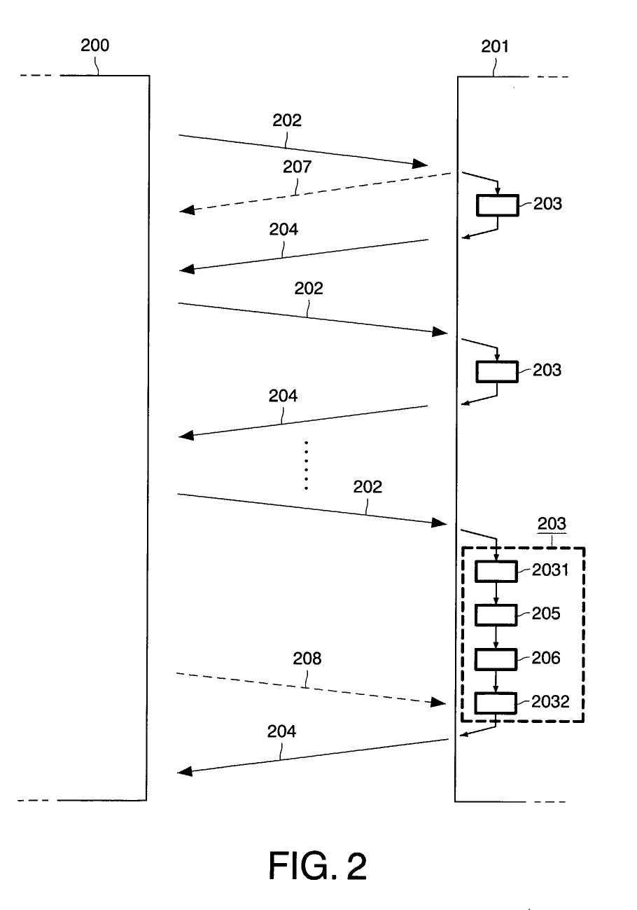

FIG. 2 shows an exchange of messages taking place between a host and a drive not according to the invention, during a write session,

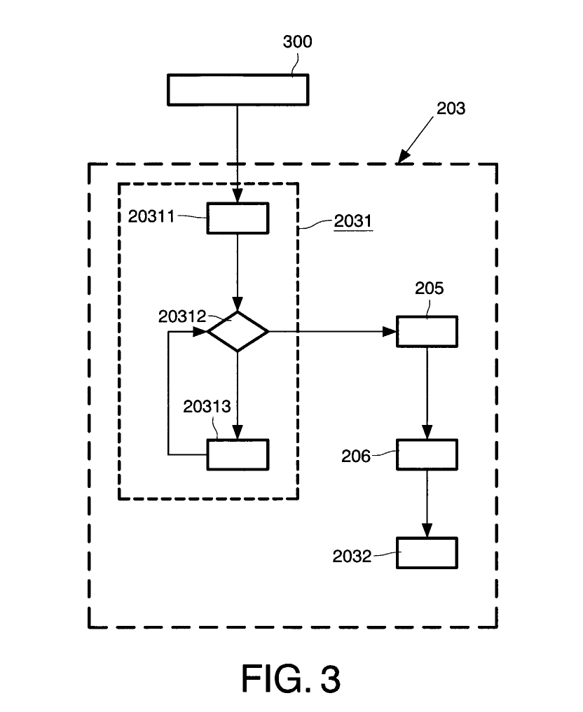

FIG. 3 shows a method of writing on a multi-layer disc not according to the invention,

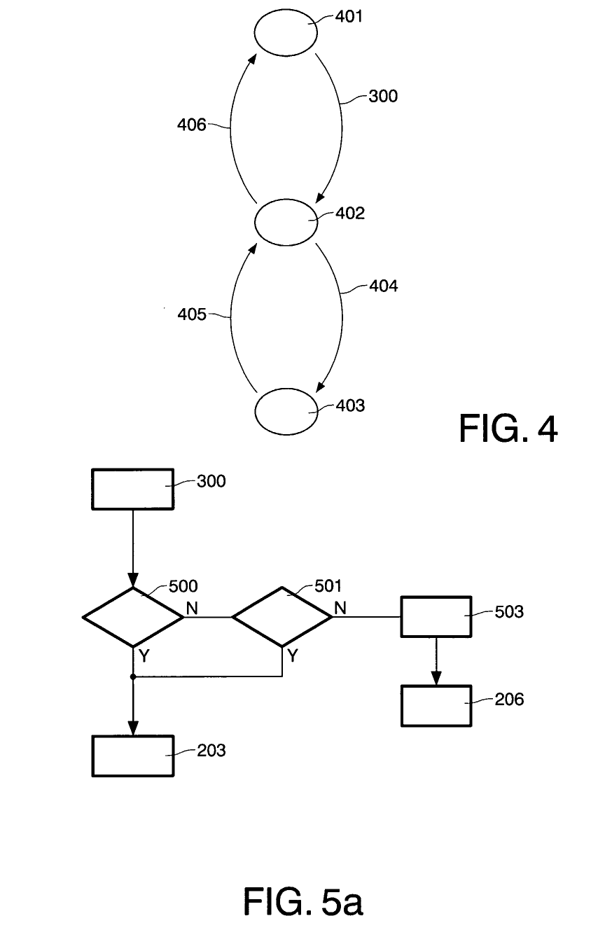

FIG. 4 shows the possible states of a drive, in relation with the method of FIG. 3,

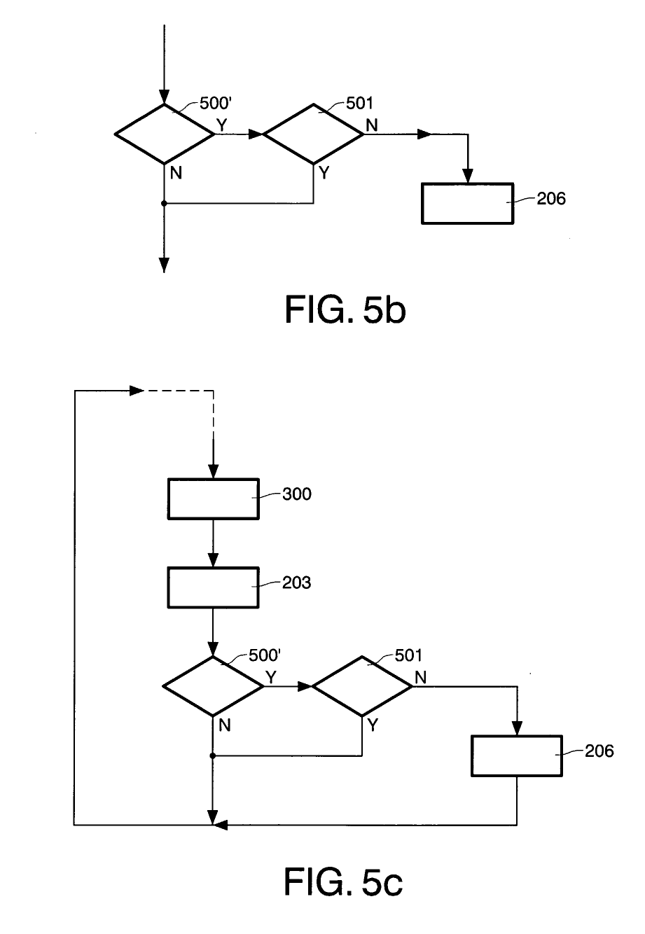

FIGS. 5a, 5b, and 5c show various embodiments of the method according to the invention,

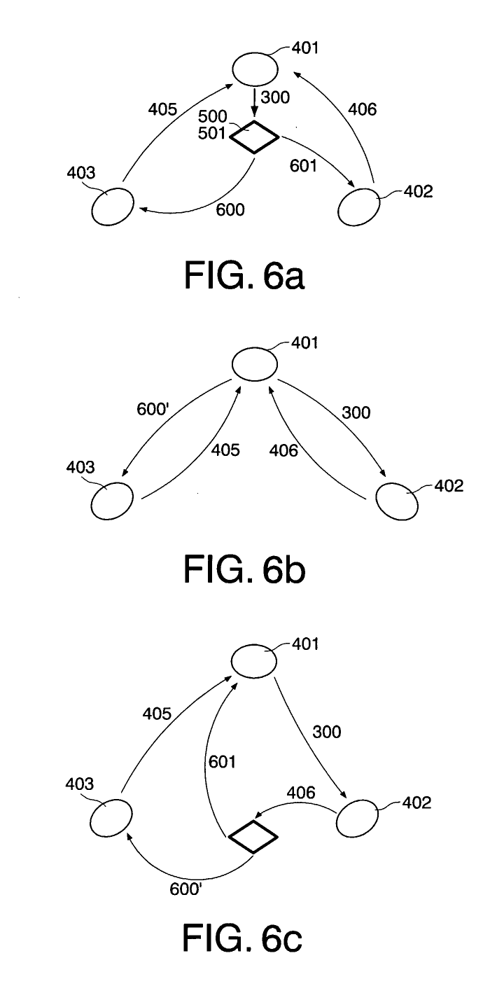

FIGS. 6a, 6b and 6c show the possible states of a drive, in relation with the methods respectively of FIGS. 5a, 5b, or 5c,

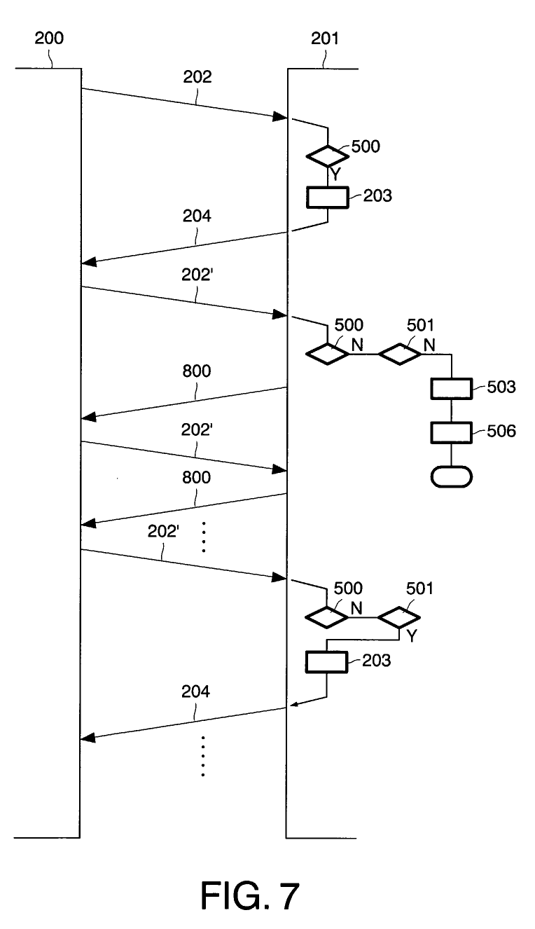

FIG. 7 shows an exchange of messages taking place between a host and a drive according to the invention during a write session,

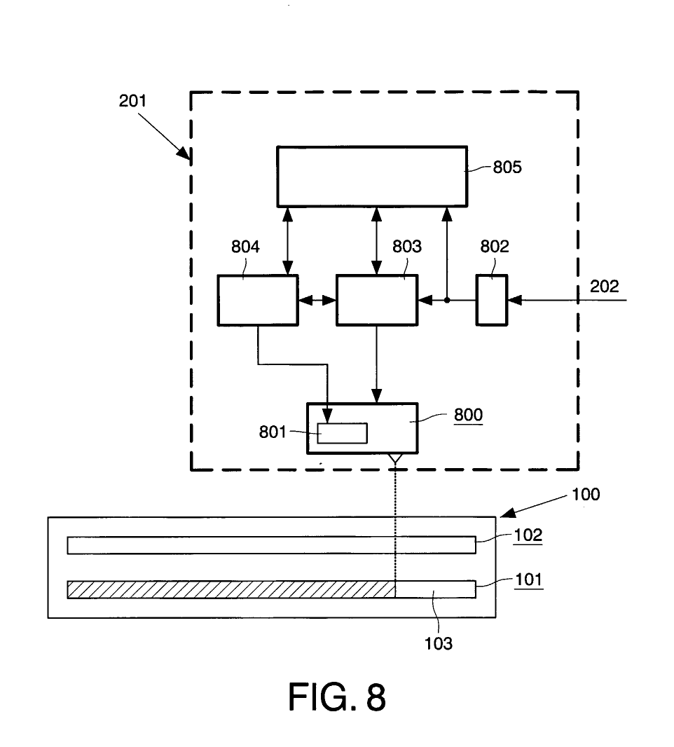

FIG. 8 shows an apparatus, or drive, according to the invention.

FIG. 1a shows an optical disc with two information layers. The optical disc 100, hereinafter referred to as the disc, comprises a first information layer 101 and a second information layer 102, each of them representing an information storage space. Typically, the disc is recorded sequentially, i.e. the information is recorded on the disc starting from the beginning of the first information layer 101 progressively filling it till the end; when the end of the first information layer 101 is reached the recording is continued on the second information layer 102, starting from its beginning progressively till the end, in other words a layer jump takes place. At some point during this sequential recording the following situation will occur: the first information layer 101 has a recorded portion 104 and a free portion 103, whereas the second information layer 102 is entirely free. The recording is sometimes referred to in the art also as writing or filling; similarly, the free portion is sometimes referred to also as non-recorded, non-written, or blank. The disc 100 can be recorded in a single session or in several sessions. A session comprises at least one, but most probably a plurality of, write commands given in succession. Such a disc may be for example a DVD+R9, a recently introduced dual-layer recordable optical disc belonging to the DVD media family, or an optical disc belonging to the BD (Blue-ray Disc) media family.

Although the invention is going to be explained with reference to a two-layer disc, the invention can equally be applied to the recording of a disc having three or more layers.

FIG. 1b shows another optical disc, with two information layers as well. In a relatively less usual but nevertheless possible way of handling such a disc 100, the information layers 101, 102 are partitioned in sectors 105. Each sector, but not necessarily the disc 100 or a layer as a whole, is recorded sequentially, i.e. the information is recorded on a sector starting from its beginning progressively to its end; when the end of the sector is reached the recording may be continued on another sector selected with some criterion out of the sectors 105 or according to a predefined order, not necessarily in a sequential order, i.e. not necessarily in the same order as the sectors 105 are disposed in the information layers. At some point during this sequential recording the following situation may occur: one of the information layers, for example the first information layer 101, will have a sector having a recorded, portion 104′ and a free portion 103′. When, during recording, the end of this sector is reached the recording is continued on another sector, which may be situated on the second information layer 102 even if on the first information layer 101 there are sectors 105 which are free or partly free.

In contrast with the situation described in reference to FIG. 1b, wherein a layer jump takes place if the free portion 103 of the first information layer 101 has been exhausted, a layer jump may take place even if the first information layer 101 has not been completely recorded.

However, a number of other events can be envisaged as causing a layer jump. For example, it may be desirable, in order to facilitate a subsequent access, to record a certain portion of information at a given position on a layer within a sequence of recordings made on a different layer. Also, a layer jump may take place before an information layer is completely exhausted, because a ring of the disc 100 near its center has been allocated as not to be recorded. In general, switching the recording from a layer to another requires the adjustment of a series of control parameters, in particular, but not only, parameters controlling the power of recording means for recording information on the disc 100. In fact the power required for recording depends on the layer where the recording is effected, since the actual fraction of power imposed to a layer largely depends on whether another layer is interposed between the writing means and the layer which is being written.

According to a common practice, an indicative value of the recording power is stored on the disc. However, since the quality of the recorded signal is largely sensitive to the used power, a fine-tuning of its value is generally necessary. This fine-tuning is achieved by a calibration procedure, known in the art at OPC, during which short portions of a recording area are recorded using different values of the recording power in the neighborhood of said indicative value. Thereafter the quality of the recorded signal in these short portions of the recording area is evaluated according to an evaluation criterion, e.g. the minimum jitter, and the recording power resulting in the best quality of the recorded signal is selected for actual use. Such a procedure may also comprise several iterations.

Other parameters, not being parameters controlling the power of the recording means, may also need a calibration, for example parameters for controlling focus or for tilt calibration.

From this it derives that as a consequence of a layer jump, a calibration procedure has to be performed for determining appropriate values of said control parameters, to be used for recording on the second information layer 102.

FIG. 2 shows an exchange of messages taking place between a host and a drive not according to the invention during a write session.

The host 200 sends to the drive 201 a series of write commands 202. Each write command 202 is specifying to record a portion of information on the disc 100, and is executed in a recording step 203. When the recording is completed the drive 201 informs the host 200 with a recording completed message 204. This protocol of communication may further include a message of write command accepted 207 sent from the drive 201 to the host 200, to inform the host 200 that a write command 202 has been received and is going to be executed. With reference in particular to the situation in which the disc 100 is filled sequentially and the first information layer 101 of the disc has a free portion 103, as explained with reference to FIG. 1a, several times the write command 202 is executed in a recording step 203, by simply recording the portion of information entirely in the first information layer 101, progressively filling the free portion 103 thereof. While progressively filling the first information layer 101 however, at some point a situation is encountered in which the free portion 103 does not suffice for storing a portion of information which is being recorded. Consequently, the recording step 203 is executed as follows: in a recording sub-step 2031 the drive 201 records the portion of information on the first information layer 101 until the free portion 103 is exhausted, then stops recording, effects a layer jump 205 and runs a calibration procedure 206 for determining appropriate value of write parameters to be used when recording on the second information layer 102, eventually in a recording sub-step 2032 recording is resumed on the second information layer 102.

The fact that a calibration procedure 206 is carried out nested within a recording step 203 makes the recording step 203 remarkably longer than usual. During the execution of a recording step 203, the host 200 is usually expecting the recording to be completed within a given amount of time, fitted for the usual duration of a recording step 203, the elapsing of which may cause an exception to be generated and eventually even the host 200 to reset the drive 201 with a reset command 208.

FIG. 3 shows the block diagram of a method of recording information on a dual-layer disc 100 not according to the invention applied by the drive 201, with reference in particular to the situation in which the disc 100 is filled sequentially and the first information layer 101 of the disc has a free portion 103, as explained with reference to FIG. 1a.

After receiving a write command 300, which can also be seen as an external event for the drive 201, follows a recording step 203, comprising: a recording sub-step 20311 during which the drive initially records the portion of information on the first information layer 101, a verifying sub-step 20312, possibly repeated a plurality of instances, during which it is verified if the free portion 103 of the first information layer 101 is exhausted, and recording sub-steps 20313, possibly repeated a plurality of instances as well, during which the portion of information is continued to be recorded on the first information layer 101 if the free portion 103 thereof is not exhausted. If instead the free portion 103 of the first information layer 101 is exhausted, a layer jump 205 is effected, after which a calibration procedure 206 is run. After the result of the calibration procedure 206 is available, the recording is resumed on the second information layer 102 in a recording sub-step 2032.

This method depicted in FIG. 3 has a corresponding representation in the state diagram of FIG. 4. In this Figure, the states of the drive 201 in respect with the execution of write commands 202 are shown. Circles represent states and arrows represent events which cause a change of state.

The drive 201 is initially in a ready state 401, during which it is idle. The receiving of a write command 300 causes the drive 201 to go into a recording state 402, during which the write command 202 is executed by recording, initially and as far as possible on the first information layer 101. After completion of recording 406 the drive 201 goes back into the ready state 401. In the event that while in the recording state 402 the free portion 103 of the first information layer 101 is exhausted 404, a layer jump 205 takes place and the drive goes into a calibrating state 403, during which the calibration procedure 206 takes place. After completion of the calibration procedure 405 the drive 201 goes back into the recording state 402, in which the recording is resumed on the second information layer 102.

FIG. 5a shows the block diagram a first embodiment of the method of recording information according to the invention, always with reference in particular to the situation described with reference to FIG. 1a.

After receiving a write command 300, follows a checking step 500, during which it is verified if the free portion 103 available on the first information layer 101 suffices for recording the portion of information specified by the write command 202 received. If yes, the write command 202 is immediately executed in the recording step 203, which recording step 203 will be entirely accomplished by recording on the first information layer 101. If not a further check 501 is made for verifying if writing parameters for recording on the second information layer 102 are already available.

If yes, the write command 202 is immediately executed in the recording step 203: in this case the free portion 103 available on the first information layer 101 will be exhausted during recording and therefore a layer jump 205 will occur; however the recording will quickly be resumed on the second information layer 102 because the recording parameters will quickly be adjusted to the values appropriate for recording on the second information layer 102 which are already available.

If not, the write command is refused 503, and in preparation for the layer jump 205 a calibration procedure 206 is carried out, clearly on the second information layer 102. Further write commands 202 which may be received while the calibration procedure 206 is run are also refused. The method may further foresee sending a message to the host 200 to inform that the drive 201 is again ready to accept a write command 202 at the end of the preparatory calibration procedure 206.

FIG. 5b shows the block diagram a second embodiment of the method of recording information according to the invention, always with reference in particular to the situation described with reference to FIG. 1a.

In the checking step 500′ of such a method it is verified if a threshold value exceeds the free portion 103 of the storage space of the first information layer 101 currently available. This threshold may be the equal to the maximum value size of the portion specified by a write command 202, if such a maximum value is specified in the protocol of communication between host 200 and drive 201.

If yes, a further check 501 is made for verifying if writing parameters for recording on the second information layer 102 are already available.

If not, a preparatory calibration procedure 206 is run. In this way it is guaranteed that as soon as the free portion 103 of the first information layer 101 is potentially not sufficient to record the portion of information specified by an incoming write command 202, a preparatory calibration procedure 206 is run. Therefore the drive 201 is always in one of the two following situations: either it is certainly able to record the portion of information which will be specified by an incoming write command 202 entirely on the first information layer 101, or the parameters for recording on the second information layer 102 have already been determined, so as to make the resumption of recording after a layer jump 205 as swift as possible. Such a checking step 500′ can be executed after the receiving of a write command 300, like in FIG. 5a, however it can also be executed independently of any received write command 202, while the drive 201 in the ready state 401. In particular, as shown in FIG. 5c, it can be executed after a recording step 203. In this way, during a write session it is made sure that the free portion 103 of the first information layer 101 available after completion of recording 406, is either sufficient to record the portion of information which will be specified by a subsequent write command 202 or the parameters for recording on the second information layer 102 have already been determined.

As it has been said, the threshold may be the equal to the maximum value size of the portion specified by a write command 202, if such a maximum value is specified in the protocol of communication between host 200 and drive 201. For example, in a Windows operating system such a maximum value is equal to 32K. As an alternative, the threshold may be equal to a few times the maximum size of the portion specified by a write command, or by a value which, according to the experience, is sufficient for recording the portion or portions specified by the subsequent write command, or few write commands. Such a threshold value does not need to be constant, but may also vary during a write session. What is important is that the calibration procedure 206 has already been performed at the moment when the values that are determined by means of the calibration procedure 206 become necessary, i.e. when a layer jump 205 occurs. At the same time the calibration procedure 206 should not be performed too long in advance of the layer jump 205, nor it should be performed unless there is a high probability that the values provided are actually going to be used. These situations should be avoided because the calibration procedure 206 is time consuming and also using a space for testing which is available in a limited quantity, therefore it should be performed only if there is a good perspective, preferably a certainty, to use its result. Moreover the result of a calibration procedure 206 heavily depends on temperature, therefore it should not be performed a long time before the layer jump 205 occurs. In particular, it is not an option to perform a calibration procedure 206 for all layers when the disc 100 is for the first time used and is completely blank, or when the disc 100 is inserted in the drive 201, or even at the beginning of the write session.

As it can be understood from these embodiments of the method according to the invention, shown in FIGS. 5a, 5b and 5c, the checking step is carried out by checking if a layer jump is going to be involved during the execution of a subsequent write command, or of a few subsequent write commands, i.e. if the condition for the layer jump to occur is met or the recording process is in proximity of meeting this condition.

These methods according to the invention depicted in FIGS. 5a, 5b and 5c have a corresponding representation in the state diagrams of FIGS. 6a, 6b and 6c respectively. In these Figures, like also in FIG. 4, the states of a drive 201 in respect with the execution of write commands 202 are shown. Circles represent states and arrows represent events causing a change of state.

In FIG. 6a the drive 201 is initially in the ready state 401, during which it is idle. The receiving of a write command 300 prompts the drive 201 to evaluate in checking steps 500, 501 if a calibration procedure is necessary 600 or not necessary 601, and accordingly goes into the calibrating state 403 or the recording state 402. Reiterated write commands 202 received while the drive is in the calibrating state 403 are refused. As it will appear clear from the foregoing discussion, the layer jump can be anticipated in different ways in the checking step 500.

In FIG. 6b, the drive 201, at any time while is initially in a ready state 401 and independently of receiving any write command 202, evaluates in checking steps 500′, 501 if a calibration procedure is necessary 600 or not necessary 601. Accordingly, the drive 201 goes into the calibrating state 403 or remains in the ready state 401. Therefore the condition of anticipating a layer jump takes priority on the execution of any write command.

In FIG. 6c, the drive 201 evaluates in steps 500′, 501 the necessity for a calibration procedure at the completion of a write command 406. Accordingly, the drive 201 goes into the calibrating state 403 or back into the ready state 401.

FIG. 7 shows a embodiment of an exchange of messages taking place between a host and a drive according to the invention during a write session, in particular with reference to the situation in which the free portion of the first information layer is about to be exhausted and a layer jump is involved.

The host 200 sends to the drive 201 a write command 202 specifying to record a portion of information. The drive 201, which, according to this example operates according to the method depicted in FIG. 5a, is triggered by the receiving of the write command 300 to check, in the checking step 500, whether the free portion 103 available on the first information layer 101 suffices for recording the portion of information specified by the write command 202 received; since the answer is positive, the drive 201 proceeds with executing the write command 202 in a recording step 203. When the recording is completed the drive 201 informs the host 200 with a recording completed message 204.

Subsequently, the host 200 sends to the drive 201 a further write command 202′ specifying to record a further portion of information. The drive 201, in a second instance of the checking step 500 checks whether the portion of information fits in the remaining free portion 103 of the first recording layer 101; this time the answer is negative and therefore a layer jump 205 is anticipated; consequently, the drive 201 checks, in the checking step 501, whether the values for the control parameters for recording on the second layer, which will be required when the layer jump 205 will have taken place, have already been determined; the answer is negative; then the drive 201 informs the host 200 that the received write command 202′ cannot be accepted with the refusal message 800, and proceeds with executing the calibration procedure 206. While the calibration procedure 206 is in progress the host 200 re-sends the write command 202′ but receives in return from the drive a refusal message 800. The host may keep re-sending the write command 202′ with the same result until completion of the calibration procedure 405. Once this has happened, a further issue of the write command 202′ causes the drive 201 to check, in a third instance of the checking step 500, whether the further portion of information fits in the remaining free portion 103 of the first recording layer 101; the answer is still negative, and the drive 201 checks, in a second instance of the checking step 501, whether the values for the control parameters for recording on the second layer have already been determined; this time the answer is positive, therefore the drive 201 proceeds with executing the write command 202′ in a recording step 203, involving a layer jump 205.

Although for this example it has been assumed that the drive operates according to the method depicted in FIG. 5a, the drive may operate also according to other embodiments of the method according to the invention, like the methods depicted in FIG. 5b or 5c. Further, where any assumptions have been made on how the protocol of communication between the host and the drive, it has to be understood that these assumptions are not essential to the invention.

FIG. 8 shows an apparatus, or drive, according to the invention. The drive 201 comprises: recording means 800 functioning in dependence of layer-dependent control parameters 801, input means 802, a command execution unit 803, a calibration unit 804, and a preparation unit 805.

The input means 802 receive one or more write commands 202 from a host specifying to record a respective portion of information, and transmit them to the command execution unit 803, which is able to execute the command by controlling the record means 800 to record the portion of information on the disc 100. With reference in particular to the situation described in FIG. 1a, each command is executed by recording the respective portion of information so as to progressively fill the first information layer 101 till the end. When the free portion 103 of the first information layer 101 is exhausted, the recording is suspended and resumed on the second information layer 102. The preparation unit 805 supervises the activity of the command execution unit 803 and the incoming write commands 202. In particular, the preparation unit 805, which, according to this example operates reflecting the method depicted in FIG. 5a, is triggered by the receiving of a write command 202 to check whether the free portion 103 available on the first information layer 101 suffices for recording the portion of information specified by the write command 202 received, in this way anticipating the occurrence of a layer jump 205. In this event the preparation unit 805 orders the calibration unit 804 to execute a calibration procedure 206 for providing the appropriate values for the control parameters 801 to be used for recording on the second information layer 102. The calibration unit 804 exploits the execution unit 805 for carrying out the recording of test patterns on a test area on the second information layer 102; the recorded test patterns are then acquired from the disc, and further processed to determine the appropriate values for the control parameters. These appropriate values are stored and will be used as actual values for the control parameters 801 when the layer jump 205 takes place, without further delay.

The invention can also be exemplified as follows. In an optical drive having DVD dual layer recording capability, when recording on the first layer and the end of the first layer is reached, recording is resumed on the second layer. However, before we can start writing on the second layer, some calibrations are needed, like for example power calibrations, focus calibration, and tilt calibration. When these calibrations have been performed, we can start writing on the second layer. The calibrations that are needed on the second layer can take a long time to complete, even up to 10 seconds or more. During this time it can happen that host communication stalls, because the data buffer in the optical drive gets full. If this happens while handling a command from the host, this command shall get stuck until there is more buffer room available. This can result in a reset from the host.

According to the invention, these calibrations on the second layer will be performed when we're near the end of the first layer, e.g. a number of sectors before the actual end of the first layer. During these calibrations, all incoming write commands shall be rejected with a failure of “LONG WRITE IN PROGRESS”. As the host application will retry this write command until it succeeds we can continue writing after the calibrations. The advantage of this invention is that this way, write commands shall always be handled within a minimal amount of time, either successfully, either being rejected with “LONG WRITE IN PROGRESS”. LONG WRITE IN PROGRESS will be reported for the time that the optical drive is performing power calibrations on the second layer. These calibrations will be performed when approaching the end of the first layer. Another implementation is to report this LONG WRITE IN PROGRESS error on the write command that actually wants to perform the layer jump.

This invention can be used in all optical drives for writing on a multi-layer media and for which layer jumps and calibrations need to be performed.

The invention can also be summarized as follows.

A method of writing on a disc having at least two layers, each layer having a storage space for storing information, the storage space of a layer comprising an available space and optionally an allocated space, comprising the steps of:
receiving a command specifying to record a portion of information, and
executing the command by starting to record the portion of information on the available space of the layer, and, if at any time during recording the portion of information the available space of the layer is exhausted, continuing recording the portion of information on another layer, characterized in that when the space available on the layer is in proximity of being exhausted, before executing the command, in a preparatory step, a calibration procedure of at least one parameter controlling the recording is executed, the result of which is to be used for recording on the other layer.

Optionally this method comprises:
after the step of receiving the command, checking if available space of the layer suffices for storing the portion of information,
if yes, executing the command,
if not, not accepting the command and performing the preparatory step.

Optionally this method comprises:
before the step of receiving the command, checking if the available space of the layer is less than a fixed value,
if yes, executing the preparatory step.

Optionally this method comprises:
after the step of executing the command, checking if the available space of the layer is less than a fixed value,
if yes, executing the preparatory step.

In an alternative formulation, the invention can be summarized as follows.

A method of writing on a disc having at least two layers, each layer having a storage space, in which method, in response to a command specifying to write a portion of information, the command is executed by starting to write the portion of information on a layer, and in executing the command, if at any time during writing the portion of information the space available on the layer is exhausted, the writing is continued on another layer, characterized in that before executing the command, in a preparatory step, a preparation for writing on the other layer is executed.

In a further alternative formulation, the invention can be summarized as follows.

A method of recording information on a disc having at least a first layer and a second layer, each of the first layer and the second layer having a storage space and a free portion thereof, the recording being in dependence of at least one control parameter, in which method a series of write commands is received, a write command specifying to record a portion of information, the execution of the command potentially implying an occurrence of a layer jump, as a result of which, recording of the portion of information initially on the first layer is discontinued and resumed on the second layer, characterized in that if the occurrence of a layer jump is anticipated, a calibration procedure for providing a value for the at least one control parameter is executed, which value is to be used for recording on the second layer.

Optionally, in this method the occurrence of a layer jump is anticipated by verifying if the portion of information specified by the write command exceeds the free portion of the first layer.

Optionally, in this method the occurrence of a layer jump is anticipated by verifying if the portion of information specified by the command exceeds the space available in the sector.

Optionally, in this method, the occurrence of a layer jump is anticipated if a fixed threshold exceeds the space available in the sector.

In a further alternative formulation, the invention can be summarized as follows.

A method of writing on a disc having at least two layers, each layer having a storage space for storing information, comprising the steps of:
receiving a command specifying to record a portion of information, and
evaluating if in the execution of the command a layer jump is likely to occur,
if yes, refusing the command and executing a calibration procedure of at least one parameter controlling the recording, the result of which is to be used for recording on the other layer,
if no, executing the command by starting to record the portion of information on the available space of the layer, and, if at any time during recording the portion of information the available space of the layer is exhausted, continuing recording the portion of information on another layer.

The invention can also be summarized as follows.

An apparatus for writing on a disc having at least two layers, each layer having a storage space for storing information, the storage space of a layer comprising an available space and optionally an allocated space, comprising:
input means, for receiving a command specifying to record a portion of information,
record means, for recording information in dependence of at least one control parameter,
a command execution unit, for, upon receiving a command, executing the command by controlling the record means to start recording the portion of information on the available space of the layer, and, if at any time during recording the portion of information the available space of the layer is exhausted, controlling the record means to continue recording the portion of information on another layer,
a calibration unit for performing a calibration procedure of the at least one control parameter, characterized in that a preparation unit for ordering the calibration unit to perform a calibration procedure when the space available on the layer is in proximity of being exhausted, before executing the command, the result of which is to be used for recording on the other layer.

In an alternative formulation, the invention can be summarized as follows.

An apparatus for recording information on a disc having at least a first layer and a second layer, each of the first layer and the second layer having a storage space and a free portion thereof, comprising:
input means, for receiving a series of write commands, a write command specifying to record a portion of information,
record means, for recording information in dependence of at least one control parameter,
a command execution unit, for, upon receiving a command, executing the command potentially implying an occurrence of a layer jump, as a result of which, recording of the portion of information initially on the first layer is discontinued and resumed on the second layer,
a calibration unit for performing a calibration procedure of the at least one control parameter, characterized in that an anticipation unit for ordering the calibration unit to execute a calibration procedure for providing a value for the at least one control parameter, which value is to be used for recording on the second layer, it the occurrence of a layer jump is anticipated.

1. A method of recording information on a recording medium (100) having at least a first information layer (101) and a second information layer (102), each of the first information layer and a second information layer comprising a free portion (103) available for recording, the recording being dependent on at least one layer-dependent control parameter (801), the recording taking place at least partly on the first information layer and involving a layer jump (205) if a condition is met, comprising:
a checking step (500, 500′) for checking if the condition, or proximity thereto, for a layer jump to occur is met;
if yes, a calibration procedure (206) for determining a value for the at least one layer dependent control parameter for recording on the second information layer.

2. A method as claimed in claim 1, wherein the condition for a layer jump (205) to occur is that the free portion (103) available for recording on the first recording layer (101) is exhausted during recording.

3. A method as claimed in claim 1, wherein the first information layer is partitioned in sectors (105), the recording taking place in a sector of the sectors, comprising a free portion (104′) available for recording, and the condition is that the free portion of the sector is exhausted during recording.

4. A method as claimed in claim 1, further comprising
receiving a write command (300) specifying to record a portion of information, and wherein the checking step (500, 500′) follows the receiving (300).

5. A method as claimed in claim 4, further comprising:
refusing the write command (503), if the condition or proximity thereto for a layer jump (205) to occur follows is verified,
executing the write command (203), otherwise.

6. A method as claimed in claim 1, wherein the checking step (500, 500′) comprises verifying if a layer jump (205) is going to be involved during the execution of a subsequent write command (202), or of a few subsequent write commands.

7. A method as claimed in claim 2, wherein the checking step (500) comprises verifying if the free portion (103) of the first recording layer (101) is sufficient to accommodate the portion of information.

8. A method as claimed in claim 1, wherein the checking step (500′) comprises verifying if the free portion (103) is less than a threshold value.

9. A method as claimed in claim 8, further comprising:
receiving a series of write commands (202) specifying to record a portions of information, which portions of information have a maximum size, and
the threshold value is equal to the maximum size.

10. A method as claimed in claim 1, wherein during the calibration procedure (206) any received write command (202) is refused.

11. An apparatus (201) for recording information on a recording medium (100) having at least a first information layer (101) and a second information layer (102), each of the first information layer and a second information layer comprising a free portion (103) available for recording, the recording taking place at least partly on the first information layer and involving a layer jump (205) if a condition is verified, comprising:
a calibration unit (804) for determining a value for at least one layer dependent control parameter (801) for recording on the second information layer;
a preparation unit (805) for checking if the condition, or proximity thereto, for a layer jump (205) to occur is met and for ordering the calibration unit to execute a calibration procedure (206) for providing a value for the at least one control parameter, which value is to be used for recording on the second information layer, if the condition, or proximity thereto, for a layer jump to occur is met; and
recording means (800) for recording information on any of the information layers, in dependence of the at least one layer-dependent control parameter.
